(19) United States
(12) Patent Application Publication
(10) Pub. No.: US 2026/0199189 A1
(43) Pub. Date: Jul. 16, 2026

(54) MEDICATION ORGANIZER WITH SMART FEATURES

(71) Applicant: RxCap, Inc., Lynnfield, MA (US)

(72) Inventors: Sreeram Ramakrishnan, Lynnfield, MA (US); Michael Furlotti, Ross, CA (US); Ram Subramanian, Fremont, CA (US)

(21) Appl. No.: 19/438,363

(22) Filed: Dec. 31, 2025

Related U.S. Application Data
(60) Provisional application No. 63/740,701, filed on Dec. 31, 2024.

(51) Int. Cl. A61J 7/00

(52) U.S. Cl. CPC A61J 7/0084; A61J 2200/70

(57) ABSTRACT

An article organizer for use with plural articles to be loaded and removed includes a housing including a chamber for removably receiving at least one cartridge, each cartridge removably storing at least one article, an organizer communication module, and an organizer communication module. The housing includes an organizer opening through which the at least one cartridge is insertable into and removable from the housing. The organizer communication module can communicate with the at least one cartridge, and send data to and/or receive data from the at least one cartridge. The organizer controller can process data from the organizer communication module and output information based on the data.

### CROSS-REFERENCE TO RELATED APPLICATIONS

This application claims the benefit under 35 U.S.C. § 119(e) of U.S. Provisional Ser. No. 63/740,701 , filed Dec. 31, 2025, the entirety of which is incorporated herein by reference.

### FIELD OF THE INVENTION

The invention relates to a smart organizer for articles, particularly medication to a user, and to devices, methods and systems for controlling medication dispensing and tracking medication compliance.

### BACKGROUND OF THE INVENTION

Medication non-compliance is a major problem in health care. Medications in the form of pills, capsules, gel-caps, pellets, tablets, etc., are typically provided to a user in a disposable plastic container with a cap. When physicians prescribe medications, they typically advise the patients of a proper medication administration, such as to take the medication at appropriate times in appropriate quantities, to continue taking the medication for the full prescribed regimen, even if the patient feels better, etc. Unfortunately, many patients exhibit poor compliance in properly following the regimens set out by their physicians.

A variety of products and techniques for reminding patients to take their medications, as prescribed, are known. Some compliance intervention systems offered by health care providers are designed to remind the patient to take the medication and alert a remote caregiver if the patient does not comply with taking the medication as prescribed. Some of these compliance intervention systems include sensors/reminders in the home, a network connection, and outbound messaging to a caregiver or even back to the patient.

Various attempts have been made to try to increase and improve the compliance of patients in the taking of their medications. Most of these systems are reminder systems. For example, there are a large number of pillbox systems that marry alarm clocks to medication containers to remind patients when it is time to take their medications.

U.S. Patent Application Publication No. 2007/0016443, for example, describes a method of providing a feedback scheme for medication to determine if a patient is complying with a specific schedule for the medication. This is accomplished by applying a special cap to a regular pill container. A sensor senses when the cap is opened and closed. A weight sensor may be provided to determine how many pills have been removed from the container. Further, the patent application publication describes the use of a pillbox with several compartments for storing pills.

Medication adherence becomes more complicated for patients managing multiple prescriptions. Medication organizers have been in use for years in order to assist patients in managing multiple prescriptions, adhere to their prescribed treatment plans, and reduce the risk of medication errors (such as missed doses or double dosing). A medication organizer, also known as a pill organizer, pill case, or dosette box, is a multicompartment compliance device designed to store and arrange scheduled doses of medications, vitamins, and supplements. While managing multiple daily medications can be a significant challenge, particularly for the elderly, individuals with memory deficiencies, or those with complex health regimens due to the increased number of bottles, varying dosages, and different timing requirements, medication organizers can simplify this complexity by administering the medications from a single source and providing a clear, visual system that can indicate whether a specific dose has been taken. That is, if a compartment is empty, the dose is presumed to have been administered, providing visual feedback to both the patient and caregivers.

Medication organizers come in a wide variety of styles and configurations to suit different needs and lifestyles. Weekly organizers typically feature seven compartments, one for each day of the week, with some versions further dividing each day into multiple slots, such as morning, noon, evening, and bedtime (or AM/PM), to accommodate medications taken at different times. Monthly organizers can be used for a longer period, featuring 31 individual daily boxes that can be color-coded or numbered. Travel organizers are compact, portable versions of daily or weekly organizers, designed to be easily carried in a purse, pocket, or travel bag, making it convenient to maintain a medication schedule while travelling. Electronic organizers, or automated pill dispensers, offer advanced features, such as audible alarms, flashing lights, or smartphone app notifications to remind users when it is time for a dose.

Medication organizers can improve medication adherence, eliminate bottle clutter, simplify the process of taking pills, and provide a quick way to visually audit compliance. However, some patients, particularly those with cognitive or motor impairments, may still make errors

### SUMMARY OF THE INVENTION

In one aspect, the invention relates to an article organizer for use with plural articles to be loaded and removed, the organizer comprising a housing including a chamber for removably receiving at least one cartridge, each cartridge removably storing at least one article, the housing including an organizer opening through which the at least one cartridge is insertable into and removable from the housing; an organizer communication module configured to communicate with the at least one cartridge, the organizer communication module sending data to and/or receiving data from the at least one cartridge; and an organizer controller configured to process data from the organizer communication module and output information based on the data.

In another aspect, the invention relates to an article organizing system for use with plural articles to be loaded and removed, the organizing system comprising a main organizer including a housing having at least one chamber, an organizer opening, and an organizer communication module; at least one cartridge including at least one cartridge cavity, at least one cartridge cavity cap, and a cartridge communications module, each cartridge removably storing at least one article, the at least one cartridge being insertable into and removable from the at least one chamber of the housing through the organizer opening, wherein the organizer communication module is configured to communicate with the at least one cartridge, the organizer communication module sending data to and/or receiving data from the at least one cartridge, and the organizer controller is configured to process data from the organizer communication module and output information based on the data.

In a further aspect, the invention relates to method of organizing plural articles in a main organizer in which at least one cartridge is mountable, the method comprising providing the main organizer including an organizer communication module; loading, in the main organizer, the at least one cartridge including at least one cartridge cavity, at least one cartridge cavity cap, and a cartridge communications module, each cartridge removably storing at least one article; and effecting communication between the organizer communication module and the cartridge communication module by sending data to and/or receiving data from the organizer communication module and the cartridge communication module, wherein the organizer is configured to process data from the organizer communication module and output information based on the data.

These and other aspects of the invention will become apparent from the following disclosure.

### BRIEF DESCRIPTION OF THE DRAWINGS

FIG. 1 illustrates a plan view of a medication organizer with stored cartridges in accordance with one embodiment of the invention.

FIG. 2 illustrates a side view of a medication cartridge having a plural medication compartments and lids.

FIG. 3 illustrates a side view of a medication cartridge having a single medication compartment and lid.

FIG. 4 illustrates a side view of an alternative medication cartridge configuration having multiple compartments and a single lid.

FIG. 5 illustrates a side view of a medication organizer housing multiple medication cartridges in a docked configuration.

FIG. 6 illustrates a cross-sectional view showing cartridge retention features that prevent removal of the cartridges when an organizer lid is closed.

FIG. 7 is a schematic diagram of the control system of an organizer of the present invention.

FIG. 8 is a schematic diagram of the control system of a cartridge of the present invention.

### DETAILED DESCRIPTION OF THE PREFERRED EMBODIMENTS

The present invention relates to an apparatus, method and system of an intelligent or smart organizer used to administer articles, particularly medicine for a patient, and for monitoring its usage. In a preferred embodiment, the dispensed medicine is in the form of pills. The term “pills,” as used herein, refers to any of capsules, gel-caps, pellets, tablets, or the like, in any particular shape or size. However, as would be understood by one of ordinary skill in the art, the present invention is not limited to only dispensing medicine, but may be used to dispense any suitable items, especially those in which compliance is monitored.

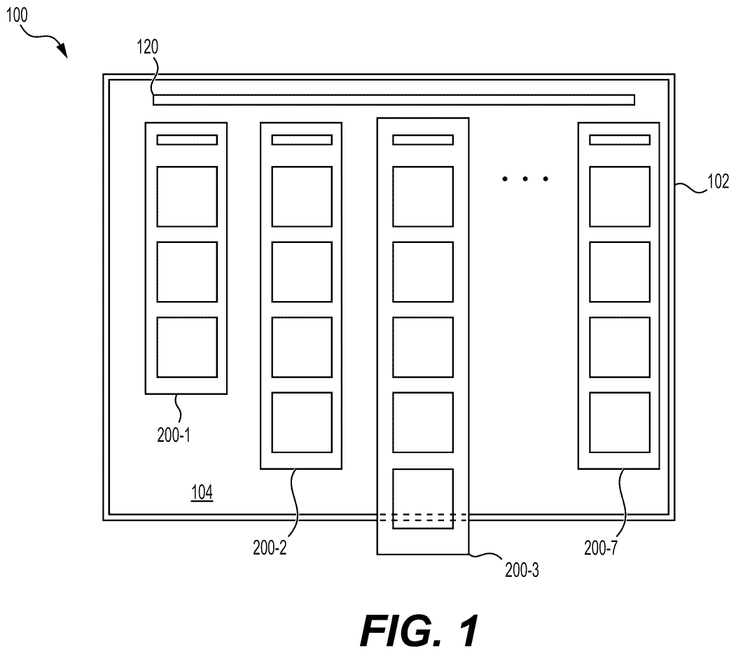

In a preferred embodiment, as shown in FIG. 1, an organizer 100 is a device which stores articles in an organized manner for distribution to a user. Hereinafter, the example of the articles being medicinal pills will be used throughout the description, but the present invention is not limited to that example. The organizer 100 includes a main body or housing 102 that defines a storing recess or space 104 for receiving one or more medicine cartridges 200 (200-1 to 200-7). While the number of storable cartridges is not limited, in a preferred embodiment, seven (7) cartridges 200 can be removably mountable in the storing recess 104 of main body 102, that is, one cartridge for each day of the week. The size and shape of each cartridge is not limited, as will be explained later, and differently sized or shaped cartridges can be stored in the same organizer 100. The size and shape of the recess 104 is not limited and can be made plural in number with recess being complementarily sized to accommodate a cartridge of a specific size. The recesses 104 can also be provided with structures to receive and guide the cartridges in and out of the recess, such structures including guide surfaces of any known design.

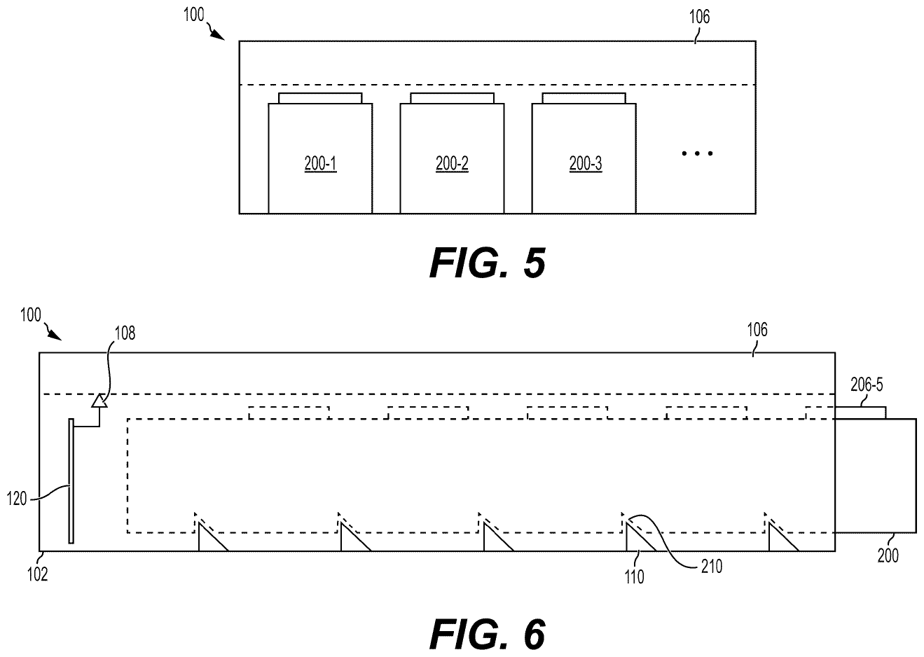

Organizer 100 further includes a lid 106 (see FIGS. 5 and 6) movable between open and closed positions. An organizer lid sensor 108, such as a switch, can detect when the lid is in the open or closed position. The lid 106 is moved to the open position to load the filled cartridges 200 into the recess 104 and allow the cassettes 200 to be removed in order to allow the pills in a particular cartridge to be distributed to the patient. In the embodiments shown in FIGS. 5 and 6, lid 106 is provided at the top of housing 102. With that arrangement, the cassettes 200 are inserted and removed through the top of the organizer. The lid 106 can also be provided at different positions, such as any side of housing 102. In that case, the cassettes 200 are inserted and removed through that side of the organizer. Organizer 100 is provided with controller 120, such as a printed circuit board (PCB) or printed circuit board assembly (PCBA) (to be described more fully later), which receives signals from lid sensor 108.

Organizer 100 is also provided with a locking mechanism 110 that can engage with the cartridges to prevent them from being removed from the recesses until permitted by the controller 120. Locking mechanism 110 can be normally in a locking state such as by spring bias and moved to an unlocked state by a lock actuator 128.

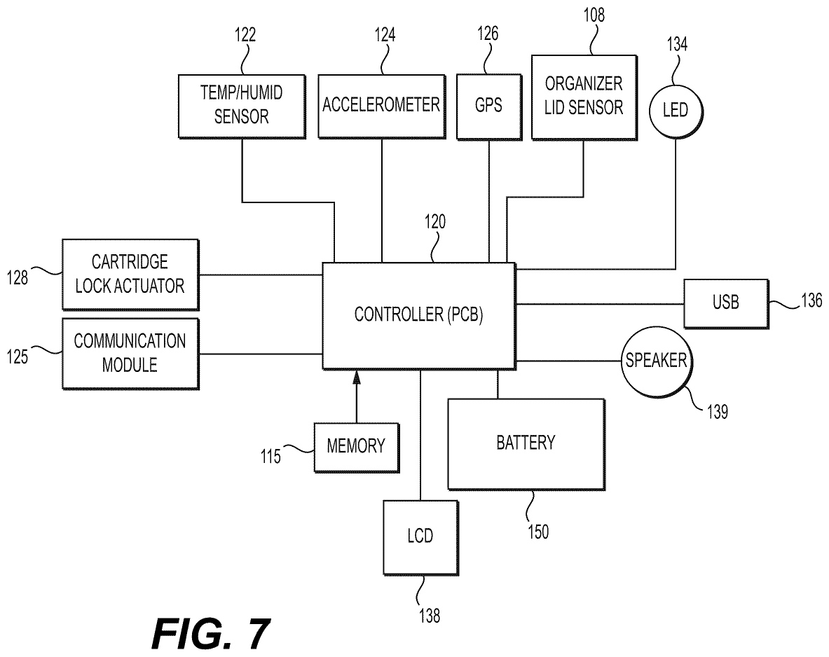

FIG. 7 is a schematic diagram of the control system of organizer 100 including electrical/electronic components of the system. As noted above, controller 120 of the smart organizer 100 can be in the form of a PCB, which receives signals from and transmits signals to the several electrical components of the smart organizer 100. Controller 120 is provided with any suitable memory 115 that it can use as a workspace and to store and retrieve data and programs. The smart organizer 100 can be provided with a temperature and/or humidity sensor 122, an accelerometer 124, and a global positioning system (GPS) unit 126 in communication with controller 120. These sensors can be of any configuration known to those in the art. The temperature and/or humidity sensor 122 can sense ambient temperature and/or humidity conditions of the smart organizer 100 and can convert those conditions into an electrical signal to supply to controller 120.

The smart organizer 100 may also have one or more LEDs 134 placed thereon. The LEDs may be illuminated in order to alert a user when it is time to take his or her medication, as will be discussed more fully below. As would be understood by one having ordinary skill in the art, multiple color LEDs may be used. Further, the location of the LEDs is not limited to any particular face of smart organizer 100. The LEDs may be placed at any location in order to alert a user.

Smart organizer 100 can also be provided with an LCD display 138 in addition to, or in place of, the LEDs. LCD display 138 can be positioned on the top of the organizer 102, for example, adjacent to the LEDs. The LCD display can perform many functions, such as alerting the user as to when it is time to take his or her medication, indicating the status of the smart organizer 100, outputting an error message, and providing dosage instructions.

GPS unit 126 can be used to track the location of the smart organizer 100. This data can be used to track the habits of the user.

The smart organizer 100 is also provided with a communications module 125 that performs several functions (as will be described later) and a USB port 136 connected to controller 120. This allows communication with the smart organizer 100 remotely or directly. In this manner, any information stored in memory 115 can be downloaded so as to track dispensing times and compliance. These connections can also be used to program the controller 120 when needed, such as when upgrading its software. In addition, USB port 136 can be used to charge rechargeable battery 150 in any known manner.

An alert device will be provided in the smart organizer 100 in order to alert a user of the time to take the medication (i.e., to remove a cartridge for that day/time) or of errors in the system. The alert device may be an audio alarm, a visual alarm, a vibration alarm, or any combination thereof. The visual alarm may be the light emitting devices (LEDs) 134 or LCD display 138. For example, one of the LEDs glows green when the user is to take a pill and another glows red when it is not yet time for the user to take a pill. The audio alarm will emit an audible signal through speaker 139 when it is time for a user to take medication and the vibrating alarm (not shown) will vibrate the smart organizer 100 when it is time for the user to take medication.

The visual alarm may be a flashing light or may be a steady light. Further, the audio alarm may emit sound in a pattern, may emit a steady sound or may be an automated voice.

Further, the smart organizer 100 is not limited to a single type of alert device. The smart organizer 100 may contain all three types of alarms, any combination of the three types of alarms, or other alerting devices not discussed herein.

The alarms in the smart organizer 100 are not only for alerting a user when to take medication, but can also alert the user if there is a system malfunction. For example, if the battery is getting too low, the smart organizer 100 could emit an audio alarm with a sound that differs from the audio alarm sound used to indicate it is time to take medication. Also, the smart organizer 100 could emit a different color LED 134 if there is a system malfunction.

The LEDs 134 may also be used to alert the user to what type of medication is in the cassettes 200 stored in the smart organizer 100. As an example, if a user is taking a variety of pills, a smart organizer 100 for heart medication could glow red, and a smart organizer 100 for diabetes medication could glow blue.

The smart organizer 100 utilizes communications module 125 to send and receive communications regarding user, prescription, and compliance information. The communications module 125 use any combination of Zigbee and/or Bluetooth technology, a cell modem, an RFID transmitter, or any other known device for sending and receiving information. Preferably, the smart organizer 100 contains more than one transceiver for redundancy. For example, the smart organizer 100 preferably contains a cell modem and Bluetooth and/or Zigbee technology.

The cell modem will allow the controller 120 to send messages, via SMS text messages or any other suitable protocol such as TCP/IP, to a central server so as to report compliance data of a user, any malfunctions, any tampering, or any misuse of the pills that is sensed by the smart organizer 100. The Bluetooth or Zigbee technology allows communication with the cassettes (to be explained more fully later) and for the organizer to be able to quickly interact with the pharmacy computing system. The pharmacy computer will detect the smart organizer 100 and its unique ID and will download any necessary data to the smart organizer 100. In particular, the PCB of controller 120 in the organizer preferably has Wi-Fi/LTE, Bluetooth Low Energy (BLE) and Near Field Communication (NFC) wireless communication capabilities. The Wi-Fi/LTE radio is used to provide updates to a host network, such as the RxCap™ cloud. The BLE and NFC functions are used to communicate with the medication cartridges to obtain medication events, times when the cartridges are in proximity, or times when docked.

Information from the cell modem may also be used by an external server to send messages to any outside source, for example, a user's family or friends, a caretaker, doctor, other healthcare provider, a researcher, pharmaceutical company, a pharmacy for refills, etc., as needed or desired. The system can have the ability to connect to enterprise workflow systems (such as pharmacy management systems) to enable monitoring by qualified healthcare providers through LTE. The locking mechanisms for locking the cartridges in the organizer or locking the lids of the compartments can be controlled remotely to prevent dispensing of medication in case a physician wants to change the medication or dose, or to prevent the patient from accidental overdoses.

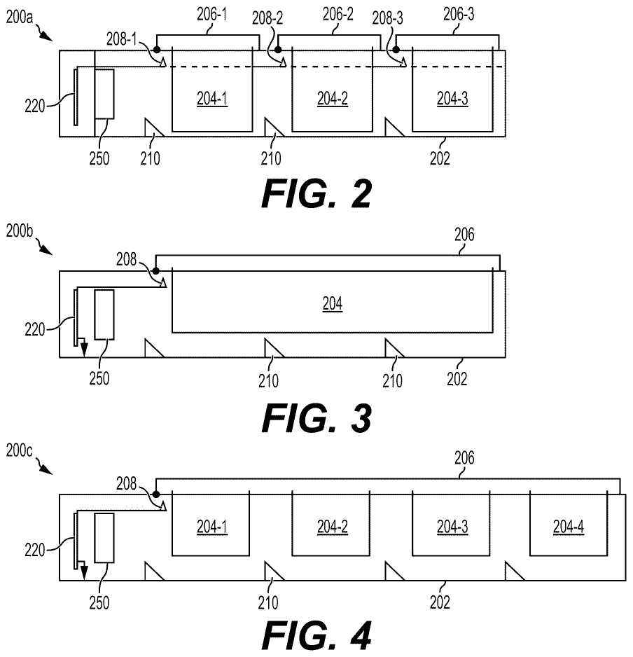

The cartridges 200 (200-1 to 200-7) of the preferred embodiments each include a cartridge housing 202 that defines one or more cartridge cavities or compartments 204 (204-1 to 204-4), in which pills can be loaded. The cavities 204 can be covered by a cartridge cap 206 (206-1 to 206-4). The cavities can be customizable for different medications or quantities of medications. The cartridges shown in FIG. 1 include three, four, or five cavities. The embodiment of FIG. 2 shows a cartridge 200a having three cavities 204-1 to 204-3, each covered by a separate lid 206-1 to 206-3, respectively. The embodiment of FIG. 3 shows a cartridge 200b having a single cavity 204 covered by a single lid 206. The embodiment of FIG. 4 shows a cartridge 200 c having four cavities 204-1 to 204-4, each covered by a single lid 206. Cartridges 200 typically fit entirely within recess 104, but such is not critical. For example, the cartridges can protrude outside of the organizer housing 102 so as to provide a region to be grasped for removal, so long as the cassette is locked in place before being released. See cassette 200-3 in FIG. 1, for example.

As noted above, each cartridge cavity 204 is covered by a cartridge cap 206 (206-1 to 206-4) movable between open and closed positions. A cartridge cap sensor 208 (208-1 to 208-3), such as a switch, can detect when the cap is in the open or closed position. The cap 206 is moved to the open position to fill the cavities 204 with pills and allow the pills in a particular cavity to be removed and distributed to the patient. Each cassette 200 is provided with controller 220, such as a PCB or PCBA, which receives signals from cap sensor 208.

Each cartridge 200 is also provided with a locking mechanism 210 that can engage with the locking mechanism 110 in organizer 100 to prevent the cartridges from being removed from the recesses until permitted by the organizer controller 120. Locking mechanisms 110, 210 can be of any known construction, such as protrusions and complementary recesses.

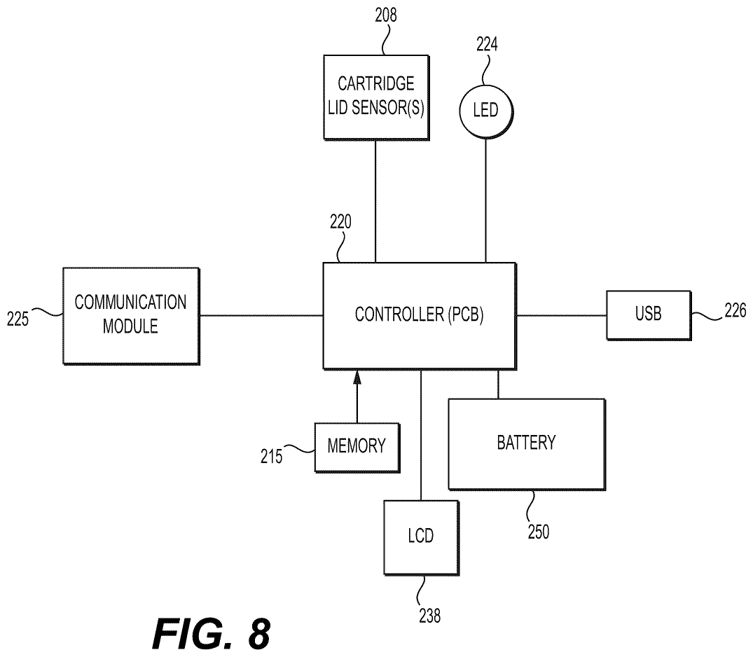

FIG. 8 is a schematic diagram of the control system of a typical cartridge 200 and can include many of the same electrical/electronic components as those of the organizer control system. As noted above, controller 220 of the smart organizer 100 can be in the form of a PCB, which receives signals from and transmits signals to the several electrical components of the cartridge 200. Controller 220 is provided with any suitable memory 215 that it can use as a workspace and to store and retrieve data and programs. Examples of the other electrical/electronic components usable in the cartridge control system are LEDs 224, LCD display 238, and USB port 226. Importantly, the cartridge control system also includes a communications module 225. The PCB of controller 220 in each cartridge 200 also preferably has Wi-Fi/LTE, Bluetooth Low Energy (BLE) and Near Field Communication (NFC) wireless communication capabilities. The Wi-Fi/LTE radio can be used to provide updates to the host network, such as the RxCap™cloud, when the cartridge is not in communication with or mounted in the organizer 100. The BLE and NFC functions can be used to communicate with the medication organizer to obtain medication events, determine when the cartridge is in proximity of the organizer, or determine when the cartridge is docked or loaded in the organizer.

The organizer 100 can be configured to act as a data hub. For example, a BLE-enabled vitals measuring device, such as a blood pressure measuring device or glucose meter, can transmit data to the network via the medication organizer 100 functioning as a hub.

The cartridges can each include a PCBA with BLE and NFC capabilities to transmit the take events to the main medication organizer. The cartridges 200 can be used either within or outside of the organizer 100. In one embodiment, the cartridges cannot be removed without the main medication organizer lid 106 being opened. The locking features in the cartridge housing can prevent it from being removed from the organizer when the lid is not open. Locking mechanisms can also be provided on the lids to enable them to be selectively locked by the controller or remotely.

The organizer 100 can house multiple cartridges (up to seven, for example) to allow a full week's medication. More cartridges (or smart caps) can be linked to the medication organizer as needed.

The cartridges 200 can be labeled or be provided with a display screen to indicate the day of the week or the medication contained, patient name or other relevant data that the patient may need. Cartridges with varying numbers of compartments can be housed in the same organizer.

The organizer 100 can be equipped with a display screen to show the patient, information regarding the medication, and/or dose or to remind the patient about the medications to be taken or when due. Additionally, the system platform can provide the information via text messages, apps, a portal such as the RxCap M portal, or a smart agent (e.g., Alexa, Siri, etc.).

The cartridges 200 can be removed from the organizer 100 and be used by the patient away from organizer. The take events can be recorded by the cartridge and can be synchronized to the network cloud when the cartridge is docked into the organizer or via an app, or when near the organizer, over BLE or NFC.

Although this invention has been described with respect to certain specific exemplary embodiments, many additional modifications and variations will be apparent to those skilled in the art in light of this disclosure. It is, therefore, to be understood that this invention may be practiced otherwise than as specifically described. Thus, the exemplary embodiments of the invention should be considered in all respects to be illustrative and not restrictive, and the scope of the invention to be determined by any claims supportable by this application and the equivalents thereof, rather than by the foregoing description.

1. An article organizer for use with plural articles to be loaded and removed, the organizer comprising:
a housing including a chamber for removably receiving at least one cartridge, each cartridge removably storing at least one article, the housing including an organizer opening through which the at least one cartridge is insertable into and removable from the housing;
an organizer communication module configured to communicate with the at least one cartridge, the organizer communication module sending data to and/or receiving data from the at least one cartridge; and
an organizer controller configured to process data from the organizer communication module and output information based on the data.

2. The organizer according to claim 1, further comprising an organizer lid and an organizer lid sensor for detecting whether the organizer lid is in an open or closed position, wherein the organizer lid sensor is configured to send data to the organizer controller to determine the position of the organizer lid.

3. The organizer according to claim 1, further comprising a locking device for releasably locking the at least one cartridge in the housing, wherein the controller controls locking and unlocking of the locking device.

4. The organizer according to claim 3, wherein articles can be removed from the at least one cartridge both when the cartridge is mounted in the housing and when the cartridge is removed from the housing.

5. The organizer according to claim 1, wherein the at least one cartridge can communicate with the organizer controller when the at least one cartridge is inserted in the housing and when the at least one cartridge is remote from the housing.

6. An article organizing system for use with plural articles to be loaded and removed, the organizing system comprising:
a main organizer including a housing having at least one chamber, an organizer opening, and an organizer communication module;
at least one cartridge including at least one cartridge cavity, at least one cartridge cavity cap, and a cartridge communications module, each cartridge removably storing at least one article, the at least one cartridge being insertable into and removable from the at least one chamber of the housing through the organizer opening, wherein
the organizer communication module is configured to communicate with the at least one cartridge, the organizer communication module sending data to and/or receiving data from the at least one cartridge, and
the organizer controller is configured to process data from the organizer communication module and output information based on the data.

7. The organizing system according to claim 6, further comprising an organizer lid and an organizer lid sensor for detecting whether the organizer lid is in an open or closed position, wherein the organizer lid sensor is configured to send data to the organizer controller to determine the position of the organizer lid.

8. The organizing system according to claim 6, further comprising a locking device for releasably locking the at least one cartridge in the housing, wherein the organizer controller controls locking and unlocking of the locking device.

9. The organizing system according to claim 8, wherein articles can be removed from the at least one cartridge both when the cartridge is mounted in the organizer housing and when the cartridge is removed from the organizer housing.

10. The organizing system according to claim 6, wherein the at least one cartridge can communicate with the organizer controller when the at least one cartridge is inserted in the organizer housing and when the at least one cartridge is remote from the organizer housing.

11. The organizing system according to claim 6, wherein the cartridge communications module can communicate with a central processing center either directly or via the organizer communications module.

12. A method of organizing plural articles in a main organizer in which at least one cartridge is mountable, the method comprising:
providing the main organizer including an organizer communication module;
loading, in the main organizer, the at least one cartridge including at least one cartridge cavity, at least one cartridge cavity cap, and a cartridge communications module, each cartridge removably storing at least one article; and
effecting communication between the organizer communication module and the cartridge communication module by sending data to and/or receiving data from the organizer communication module and the cartridge communication module, wherein
the organizer is configured to process data from the organizer communication module and output information based on the data.

13. The method according to claim 12, further comprising releasably locking the at least one cartridge in the organizer.

14. The method according to claim 12, wherein articles can be removed from the at least one cartridge both when the cartridge is mounted in the organizer and when the cartridge is removed from the organizer.

15. The method according to claim 14, wherein the at least one cartridge can communicate with the organizer when the at least one cartridge is inserted in the organizer and when the at least one cartridge is remote from the organizer.

16. The method according to claim 6, wherein the cartridge communications module communicates with a central processing center either directly or via the organizer communications module.
